(19) United States
(12) Patent Application Publication
(10) Pub. No.: US 2019/0320484 A1
(43) Pub. Date: Oct. 17, 2019

(54) Service Connection Control Method and Terminal

(71) Applicant: Huawei Technologies Co., Ltd., Shenzhen (CN)

(72) Inventors: Lei Mou, Nanjing (CN); Sen Li, Nanjing (CN)

(21) Appl. No.: 16/063,947

(22) PCT Filed: Jan. 28, 2016
(86) PCT No.: PCT/CN2016/072530

§ 371 Date: Jun. 19, 2018

(51) Int. Cl. H04W 76/25; H04L 29/12; H04L 12/26; H04L 12/24

(52) U.S. Cl. CPC H04W 76/25; H04L 41/0686; H04L 43/10; H04L 61/1541

(57) ABSTRACT

A service connection control method and a terminal, where the method includes detecting, by the terminal, that a network signal is interrupted, maintaining, by the terminal, a first service connection to a server, where the first service connection is used for communication between the server and the terminal before the network signal is interrupted, detecting, by the terminal, that the network signal recovers to normal, and reusing, by the terminal, the first service connection when an Internet Protocol (IP) address of the terminal does not change within a first time interval, where the first time interval is a time interval between a moment at which the network signal is interrupted and a moment at which the network signal recovers to normal.

### CROSS-REFERENCE TO RELATED APPLICATION

This application is a U.S. National Stage of International Patent Application No. PCT/CN2016/072530 filed on Jan. 28, 2016, which is hereby incorporated by reference in its entirety.

### TECHNICAL FIELD

The present disclosure relates to the communications field, and in particular to a service connection control method and a terminal.

### BACKGROUND

With popularization of smartphones, more people surf the Internet by means of mobile networks. In a mobile network, signals may become unstable in places such as an elevator and a subway. In this case, a mobile phone temporarily cannot send or receive a signal. Most applications on a mobile phone communicate with a server by means of a Transmission Control Protocol (TCP) connection. When network signals are unstable, the mobile phone continually broadcasts that a network signal is interrupted and that a network signal is recovered. The applications on the mobile phone repeatedly initiate operations of disconnecting from the server and re-establishing a connection to the server. The continual attempts of the applications to re-establish a connection to the server result in high power consumption and network traffic consumption of the mobile phone. In addition, the re-establishment of the TCP connection between the mobile phone and the server requires processes of a three-way handshake and system authentication. Therefore, the connection re-establishment also causes a network delay.

### SUMMARY

Embodiments of the present disclosure provide a service connection control method and a terminal to reuse an original service connection to the maximum extent, and reduce network delays caused by service connection re-establishment.

According to a first aspect, a service connection control method is provided, including determining, by a terminal, that a network signal is interrupted, maintaining, by the terminal, a first service connection to a server, where the first service connection is a service connection that is used for communication between the server and the terminal before the network signal is interrupted, determining, by the terminal, that the network signal recovers to normal, and reusing, by the terminal, the first service connection if an Internet Protocol (IP) address of the terminal does not change within a first time interval, where the first time interval is a time interval between a moment at which the network signal is interrupted and a moment at which the network signal recovers to normal.

In this implementation, when a network signal is interrupted, a service connection between a server and a terminal is not blindly disrupted. Instead, when an IP address of the terminal does not change after the network signal recovers, the original service connection is still used, network delays caused by connection re-establishment are reduced, and a traffic bandwidth and power consumption of the terminal are reduced.

With reference to the first aspect, in a first implementation of the first aspect, the method further includes establishing, by the terminal, a third service connection to the server if the IP address of the terminal changes within the first time interval.

In this implementation, when a network signal is interrupted, a service connection between a server and a terminal is not blindly disrupted. Instead, a service connection is re-established when an IP address of the terminal changes after the network signal recovers. That is, a service connection is re-established only when the original service connection between the server and the terminal is indeed unavailable. Therefore, the original service connection can be reused to the maximum extent, network delays caused due to connection establishment are reduced, and a traffic bandwidth and power consumption of the terminal are reduced.

With reference to the first aspect or the foregoing implementation, in a second implementation of the first aspect, reusing, by the terminal, the first service connection if an IP address of the terminal does not change within a first time interval includes determining that the IP address of the terminal does not change within the first time interval, sending a probe request message to the server, where the probe request message is used to detect a network status between the terminal and the server, receiving a probe response message sent by the server, where the probe response message is a response message for the probe request message, and reusing, by the terminal, the first service connection if the probe response message indicates that the network status between the server and the terminal is normal.

In this implementation, in an actual application scenario, an IP address of a terminal may not change, but a link between a server and the terminal, or the server, or the terminal may be faulty. In this case, to further improve reliability, the terminal may send a probe request message to the server to detect a network status between the terminal and the server, and then determine, according to a probe response message, whether to reuse an original service connection. Optionally, when the probe response message indicates that the network status is normal, the original service connection is reused.

With reference to the first aspect or the foregoing implementation, in a third implementation of the first aspect, the method further includes establishing, by the terminal, a second service connection to the server if the probe response message indicates that the network status between the server and the terminal is abnormal.

In this implementation, the terminal may determine, according to the probe response message, whether to reuse the original service connection, thereby further improving reliability of the reused original service connection. That is, the original service connection is still used only when the original service connection has high reliability. When the probe response message indicates that the network status is abnormal, that is, the original service connection is unavailable, a service connection is re-established.

With reference to the first aspect or the foregoing implementation, in a fourth implementation of the first aspect, reusing, by the terminal, the first service connection if an IP address of the terminal does not change within a first time interval includes reusing, by the terminal, the first service connection if the IP address of the terminal does not change within the first time interval, and the first time interval is less than a first time interval threshold.

In this implementation, if network interruption lasts excessively long, the terminal may choose to re-establish a service connection to the server, to improve user experience.

With reference to the first aspect or the foregoing implementation, in a fifth implementation of the first aspect, reusing, by the terminal, the first service connection if an IP address of the terminal does not change within a first time interval includes reusing, by the terminal, the first service connection if the IP address of the terminal does not change within the first time interval, and a distance between a first position and a second position of the terminal is less than a first distance threshold, where the first position is a position of the terminal when the network signal is interrupted, and the second position is a position of the terminal when the network signal recovers to normal.

In this implementation, if a movement distance of the terminal is excessively large, it may be considered that the original service connection is unavailable, and a network connection needs to be re-established. Therefore, in this embodiment of the present disclosure, the original service connection may be reused when the movement distance of the terminal is less than a threshold.

According to a second aspect, a terminal is provided. The terminal includes various modules configured to execute the method in the first aspect or any implementation of the first aspect.

According to a third aspect, a terminal is provided, including a transceiver, a processor, a memory, and a bus system. The transceiver, the processor, and the memory are connected to each other using the bus system. The memory is configured to store an instruction. The processor is configured to execute the instruction stored in the memory. When executing the instruction stored in the memory, the processor is enabled to execute the method in the first aspect or any implementation of the first aspect.

Based on the foregoing technical solutions, according to the service connection control method and the terminal in the embodiments of the present disclosure, when a network signal is interrupted, a service connection between a server and a terminal is not blindly disrupted. Instead, when an IP address of the terminal does not change after the network signal recovers, the original service connection may be reused, network delays caused by connection re-establishment are reduced, and a traffic bandwidth and power consumption of the terminal are reduced.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a signaling flowchart in an application scenario according to an embodiment of the present disclosure;

FIG. 2 is a schematic flowchart of a service connection control method according to an embodiment of the present disclosure;

FIG. 3 is a logical flowchart of a service connection control method according to another embodiment of the present disclosure;

FIG. 4 is a signaling flowchart of a service connection control method according to an embodiment of the present disclosure;

FIG. 5 is a schematic block diagram of a terminal according to an embodiment of the present disclosure; and

FIG. 6 is a schematic block diagram of a terminal according to another embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

The technical solutions of the present disclosure may be applied to various communications systems, such as a Global System for Mobile Communications (GSM), a Code Division Multiple Access (CDMA) system, a Wideband CDMA (WCDMA), a general packet radio service (GPRS), and a Long Term Evolution (LTE).

User equipment (UE), also referred to as a mobile terminal (MT), mobile UE, and the like, may communicate with one or more core networks using a radio access network (RAN). The UE may be an MT, such as a mobile phone (also referred to as a “cellular” phone) and a computer with an MT. For example, the UE may be a portable, pocket-sized, handheld, computer built-in, or in-vehicle mobile apparatus.

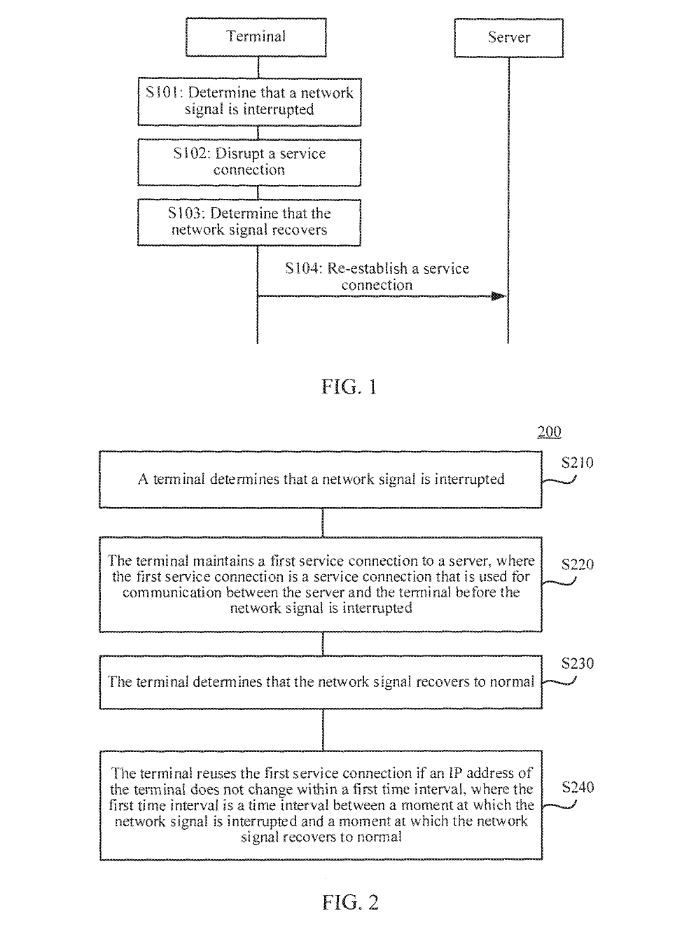

Before the embodiments of the present disclosure are described, a processing manner in the other approaches when a signal is unstable is first described. FIG. 1 is a signaling flowchart when a signal is unstable.

Step S101: A terminal determines that a network signal is interrupted.

The terminal periodically detects a status of the network signal. When the network signal is interrupted, a communications unit in the terminal sends a broadcast message. The broadcast message is used to notify all applications on the terminal that the network signal is interrupted such that after receiving the broadcast message, the applications on the terminal disable an already established service connection to a server.

Step S102: The terminal disrupts a service connection to a server.

When determining that the network signal is interrupted, the terminal needs to send a finish (FIN) packet. The FIN packet disables the service connection between the server and the terminal.

Step S103: The terminal determines that the network signal recovers.

Further, when the terminal detects that the network signal recovers to normal, the communications unit in the terminal sends another broadcast message. The broadcast message is used to notify all the applications on the terminal that the network signal recovers to normal such that after receiving the broadcast message, the applications on the terminal establish a new service connection to the server.

Step S104: The terminal re-establishes a service connection to the server.

In an embodiment, a time interval between interruption and recovery of the network signal is usually short. In most cases, an original service connection between the server and the terminal is still available. Therefore, when the network signal is interrupted, it is not proper to blindly disrupt the network connection between the server and the terminal. Therefore, the embodiments of the present disclosure provide a service connection control method, to reuse the original service connection to the maximum extent.

FIG. 2 is a schematic flowchart of a service connection control method 200 according to an embodiment of the present disclosure. The method 200 may be executed by a terminal. As shown in FIG. 2, the method 200 includes the following steps.

Step S210: A terminal determines that a network signal is interrupted.

Step S220: The terminal maintains a first service connection to a server, where the first service connection is a service connection that is used for communication between the server and the terminal before the network signal is interrupted.

Step S230: The terminal determines that the network signal recovers to normal.

Step S240: The terminal reuses the first service connection if an IP address of the terminal does not change within a first time interval, where the first time interval is a time interval between a moment at which the network signal is interrupted and a moment at which the network signal recovers to normal.

Further, the terminal periodically detects a status of the network signal. When the terminal is in places such as an elevator and a subway in which the signal is unstable, the network signal is interrupted intermittently. In this case, the terminal detects that the network signal is interrupted. A communications unit in the terminal sends a first broadcast message to an application unit in the terminal. The first broadcast message is used to notify all application units in the terminal that the current network signal is interrupted. In the other approaches, when the network signal is interrupted, the terminal disables an already established service connection to the server, and re-establishes a service connection between the terminal and the server after the network signal recovers. However, in an actual application scenario, when the network signal is interrupted, if the terminal does not send a FIN packet to the server, that is, the server does not receive the FIN packet sent by the terminal, the server considers that the service connection still exists. An application layer of the server detects, according to heartbeats, whether the service connection exists. Usually, a period of heartbeat detection is relatively long, and the application layer considers that the service connection is faulty only after the service connection cannot be detected by means of multiple times of heartbeat detection. Therefore, regardless of short-time interruption of the network signal, the server still considers that the service connection is available, provided that the terminal does not send the FIN packet. If the network signal recovers before the application layer discovers, according to heartbeats, that the service connection is faulty, in this case, the server considers that the service connection is available. If the IP address of the terminal does not change, the service connection already established between the terminal and the server before the network signal is interrupted is still available. Therefore, optionally, in this embodiment of the present disclosure, after determining that the network signal is interrupted, the terminal maintains the original service connection to the server. After the first time interval, the terminal determines that the network signal recovers. In this case, the application unit in the terminal receives a second broadcast message sent by the communications unit in the terminal. The second broadcast message is used to notify the application unit that the current network signal recovers. The terminal may determine, according to whether the IP address of the terminal changes within the first time interval, whether to reuse the original service connection between the terminal and the server or re-establish a service connection between the terminal and the server. Optionally, when the IP address of the terminal does not change, the terminal may consider that the original service connection established between the server and the terminal before the network signal is interrupted is still available. The terminal may choose to communicate with the server still using the original service connection.

Therefore, according to the service connection control method in this embodiment of the present disclosure, when a network signal is interrupted, a service connection between a server and a terminal is not blindly disrupted. Instead, when an IP address of the terminal does not change after the network signal recovers, the original service connection may be reused, network delays caused by connection re-establishment are reduced, and a traffic bandwidth and power consumption of the terminal are reduced.

For example, an instant messaging (IM) application on a mobile phone usually maintains a long-time service connection to the server in order to receive a chat message or a notification message sent by the server. When a user enters a place such as an elevator or a subway with the mobile phone, a mobile phone signal may be interrupted. In this case, an operating system of the mobile phone notifies, in a broadcast manner, the application that the network signal is interrupted. In the other approaches, the mobile phone disables the service connection to the server, and then re-establishes a connection after the network signal recovers. However, by means of the service connection control method in this embodiment of the present disclosure, the mobile phone maintains the service connection to the server. When the user gets out of the place such as the elevator or the subway, at this time, the mobile phone detects that the network signal recovers. In this case, the mobile phone determines that the IP of the mobile phone does not change, and the original service connection may be reused for communication.

Optionally, for an ANDROID mobile phone terminal, the first broadcast message may be an android.net.conn.CONNECTIVITY_CHANGE broadcast message. When the network signal is interrupted, an operating system of the mobile phone controls a communications unit in the mobile phone to send the android.net.conn.CONNECTIVITY_CHANGE broadcast message in order to notify all application units in the mobile phone that the current network signal is interrupted. The second broadcast message may be an android.net.conn.CONNECTIVITY_CHANGE broadcast message. When the network signal recovers, the operating system of the mobile phone controls the communications unit in the mobile phone to send the android.net.conn.CONNECTIVITY_CHANGE broadcast message in order to notify all the application units that the current network signal recovers such that the terminal re-establishes a service connection to the server. Optionally, the broadcast message carries an EXTRA_NO_CONNECTIVITY parameter. The parameter may indicate a current network status. If a value of the parameter is true, it indicates that a current network is interrupted. If a value of the parameter is false, it indicates that a current network is not interrupted.

Optionally, in an embodiment, the method 200 further includes establishing, by the terminal, a third service connection to the server if the IP address of the terminal changes within the first time interval.

Further, if the IP address of the terminal changes, for example, a mobile phone terminal of China Mobile accesses a nearest network, and if the mobile terminal is in a roaming state (for example, in another province), an IP address of the mobile phone changes, in this case, it may be considered that the service connection between the server and the terminal before the network signal is interrupted is unavailable after a network recovers. After the network signal recovers, the terminal needs to re-establish a service connection to the server for normal communication.

Optionally, in an embodiment, reusing, by the terminal, the first service connection if an IP address of the terminal does not change within a first time interval includes determining that the IP address of the terminal does not change within the first time interval, sending a probe request message to the server, where the probe request message is used to detect a network status between the terminal and the server, receiving a probe response message sent by the server, where the probe response message is a response message for the probe request message, and reusing, by the terminal, the first service connection if the probe response message indicates that the network status between the server and the terminal is normal. Further, in a case of only handover between base stations or cells, the IP address of the terminal does not change. For example, a mobile phone terminal of China Unicom accesses a network according to a home location, and an IP address of the terminal still does not change even in a roaming state. When the IP address of the terminal does not change, it may be considered that the original service connection between the server and the terminal before the network signal is interrupted is still available. In this case, the terminal may communicate with the server still using the original service connection. Alternatively, to further ensure reliability, the terminal may send the probe request message to the server. The probe request message is used to detect the network status between the terminal and the server. Then, the terminal determines, according to the actual network status between the terminal and the server, whether to reuse the original service connection or re-establish a service connection to the server. For example, the terminal may determine, according to the probe response message, whether to reuse the original service connection or re-establish a service connection to the server. The probe response message is a response message for the probe request message. The probe response message may be used to indicate the current network status. Optionally, when the probe response message indicates that the current network status is normal, the terminal may choose to communicate with the server by reusing the original service connection. For example, when the terminal receives a connection successful message indicating that the network status between the terminal and the server is normal, in this case, the terminal may choose to communicate with the server by reusing the original service connection. When the probe response message indicates that the current network status is abnormal, for example, a network adapter of the server is faulty, or software of the server is faulty, or other link problems occur, the terminal cannot normally communicate with the server. In this case, the terminal may choose to re-establish a service connection to the server.

Optionally, in an embodiment, the method 200 further includes establishing, by the terminal, a second service connection to the server if the probe response message indicates that the network status between the server and the terminal is abnormal.

Further, when the terminal receives the probe response message indicating that the service connection between the server and the terminal is abnormal, for example, when the terminal receives a connection reset message, it indicates that the network status between the terminal and the server is abnormal. The terminal needs to re-establish a service connection to the server for normal communication. In other words, although the IP address of the terminal does not change, in this case, if the server is faulty or other link problems occur, the network status between the server and the terminal may be abnormal. In this case, the original service connection is unavailable. Therefore, the terminal needs to re-establish a service connection to the server for subsequent communication.

Optionally, the probe request message may be a user-defined message packet, and is used to detect the network status between the server and the terminal. When needing to detect the network status between the terminal and the server, the terminal sends the message packet to the server. When receiving the message packet, the server may return a self-defined message packet to indicate the current network status. This is not limited in this embodiment of the present disclosure.

It should be understood that in this embodiment of the present disclosure, that connection successful is used to indicate that the network status is normal and connection reset is used to indicate that the network status is abnormal is merely an example, and does not constitute any limitation to this embodiment of the present disclosure. In this embodiment of the present disclosure, alternatively, connection ok may be used to indicate that the network status is normal and connection failure may be used to indicate that the network status is abnormal, or the like. This embodiment of the present disclosure is not limited thereto.

Optionally, in this embodiment of the present disclosure, reusing, by the terminal, the first service connection if an IP address of the terminal does not change within a first time interval includes reusing, by the terminal, the first service connection if the IP address of the terminal does not change within the first time interval, and the first time interval is less than a first time interval threshold.

Further, in this embodiment of the present disclosure, when the IP address of the terminal does not change within the first time interval, the original service connection may be reused. However, if the first time interval is greater than a threshold, that is, a network has been interrupted for an excessively long time, a user needs to wait for an excessively long time. In this case, if a service connection is still not re-established, user experience is affected. Therefore, in this embodiment of the present disclosure, when the IP address of the terminal does not change within the first time interval, and the first time interval is less than the first time interval threshold, the original service connection may be reused. This not only ensures that the original service connection can be used to the maximum extent, but also ensures that the user experience is not affected due to an excessively long waiting time. Optionally, if the first time interval is greater than the first time threshold, the terminal may choose to re-establish a service connection to the server to ensure normal use of the user.

Optionally, in an embodiment, reusing, by the terminal, the first service connection if an IP address of the terminal does not change within a first time interval includes reusing, by the terminal, the first service connection if the IP address of the terminal does not change within the first time interval, and a distance between a first position and a second position of the terminal is less than a first distance threshold, where the first position is a position of the terminal when the network signal is interrupted, and the second position is a position of the terminal when the network signal recovers to normal.

Further, in this embodiment of the present disclosure, when the IP address of the terminal does not change within the first time interval, the original service connection may be reused. However, if a movement distance of the terminal is greater than a threshold within the first time interval, it may be understood as that the network has been interrupted for an excessively long time, or it may be understood as that an excessively large movement distance may result in a change of the IP address. In this case, the terminal needs to re-establish a connection to the server. Therefore, in this embodiment of the present disclosure, when the IP address of the terminal does not change within the first time interval, and the movement distance of the terminal within the first time interval is less than the first distance threshold, the original service connection may be reused. Optionally, if the movement distance is greater than the first distance threshold, the terminal may choose to re-establish a service connection to the server.

Therefore, according to the service connection control method in this embodiment of the present disclosure, when a network signal is interrupted, a service connection between a server and a terminal is not blindly disrupted. Instead, it may be determined, according to whether an IP address of the terminal changes after the network signal recovers, whether to still use the original service connection or re-establish a service connection. Therefore, the original service connection can be reused to the maximum extent, network delays caused due to connection re-establishment are reduced, and a traffic bandwidth and power consumption of the terminal are reduced.

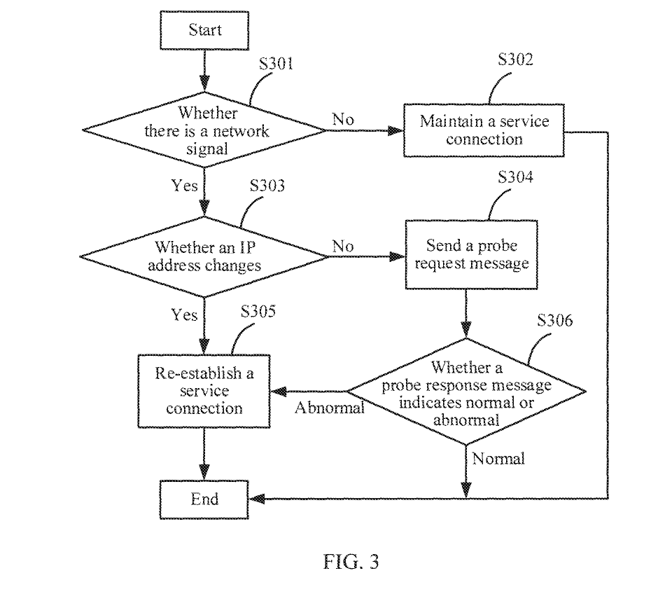

FIG. 3 is a schematic flowchart of a service connection control method according to a specific embodiment of the present disclosure.

Step S301: A terminal determines whether there is a network signal.

If there is no network signal, the procedure goes to step S302, otherwise, the procedure goes to step S303.

Step S302: The terminal maintains an original service connection to a server. The original service connection is a service connection that is used for communication between the server and the terminal before the network signal is interrupted. That is, in this embodiment of the present disclosure, when the network signal is interrupted, the terminal does not blindly disrupt the service connection. Instead, the terminal first maintains the original service connection between the server and the terminal.

Step S303: Determine whether an IP address of the terminal changes.

If the IP address of the terminal does not change, the procedure goes to step S304, otherwise, the procedure goes to step S305, in which the terminal re-establishes a service connection to the server.

Step S304: The terminal sends a probe request message to the server. The probe request message is used to detect a network status between the server and the terminal.

Optionally, the terminal may detect, using a ping command, whether a network between the server and the terminal is normal. For example, whether the network between the server and the terminal is normal may be detected by pinging an IP address of the server. Further, the terminal may determine, by sending a data packet to the server and then requesting the server to return a same data packet, whether the network between the server and the terminal is normal. If the data packet returned by the server and the data packet sent by the terminal are the same, it is determined that the network between the terminal and the server is normal, otherwise, it is determined that the network between the terminal and the server is abnormal.

Step S306: Receive a probe response message of the server, and determine, according to the probe response message, whether a network status is normal or abnormal.

For example, if the terminal detects the network status using the ping command, when the data packet returned by the server and the data packet sent by the terminal are the same, the terminal may determine that the network status is normal, otherwise, determine that the network status is abnormal.

If the network status is normal, the procedure ends, and the terminal communicates with the server still using the original service connection. If the network status is abnormal, the procedure goes to step S305, in which the terminal re-establishes a service connection to the server.

Therefore, according to the service connection control method in this embodiment of the present disclosure, when a network signal is interrupted, a service connection between a server and a terminal is not blindly disrupted. Instead, it may be determined, according to whether an IP address of the terminal changes after the network signal recovers, whether to still use the original service connection or re-establish a service connection. Therefore, the original service connection can be reused to the maximum extent, network delays caused due to connection re-establishment are reduced, and a traffic bandwidth and power consumption of the terminal are reduced.

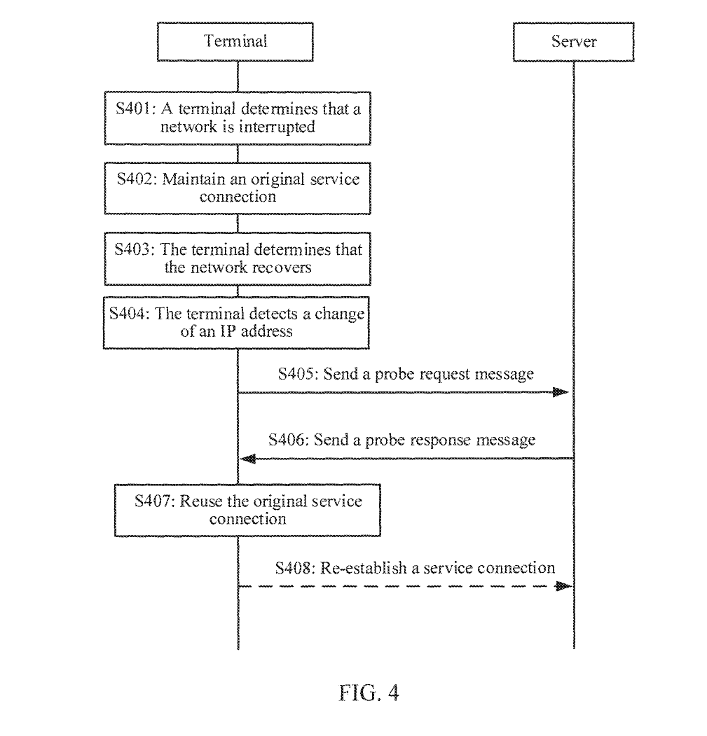

FIG. 4 is a signaling flowchart of a service connection control method according to a specific embodiment of the present disclosure.

Step S401: At a first moment, a terminal device detects that a network signal is interrupted.

Step S402: When the network signal is interrupted, the terminal maintains an original service connection to a server. The original service connection is a service connection that is used for communication between the server and the terminal before the network signal is interrupted.

Further, in the other approaches, when a network is interrupted, the terminal sends a FIN packet to the server, to disrupt the service connection to the server. In this embodiment of the present disclosure, when the network signal is interrupted, the terminal does not send the FIN packet to the server. That is, in this case, the server still considers the current service connection available. When the network signal recovers, if an IP address of the terminal does not change, the terminal may communicate with the server by reusing the current service connection, thereby saving a process of re-establishing a service connection.

Step S403: At a second moment, the terminal device detects that the network signal recovers.

Step S404: The terminal detects whether an IP address of the terminal changes within a first time interval between the first moment and the second moment.

If the IP address of the terminal does not change within the first time interval, the procedure goes to step S405.

Otherwise, the procedure goes to step S408, in which the terminal re-establishes a service connection to the server.

Step S405: The terminal sends a probe request message to the server. The probe request message is used to detect a network status between the terminal and the server.

Step S406: The terminal receives a probe response message sent by the server. The probe response message is a response message for the probe request message, and the probe response message is used to indicate the network status between the server and the terminal.

If the probe response message indicates that the current network status is normal, the procedure goes to step S407, and the terminal may perform network communication with the server by reusing the original service connection.

If the probe response message indicates that the current network status is abnormal, the procedure goes to step S408, in which the terminal re-establishes a service connection to the server.

Therefore, according to the service connection control method in this embodiment of the present disclosure, when a network signal is interrupted, a service connection between a server and a terminal is not blindly disrupted. Instead, it may be determined, according to whether an IP address of the terminal changes after the network signal recovers, whether to still use the original service connection or re-establish a service connection. Therefore, the original service connection can be reused to the maximum extent, network delays caused due to connection re-establishment are reduced, and a traffic bandwidth and power consumption of the terminal are reduced.

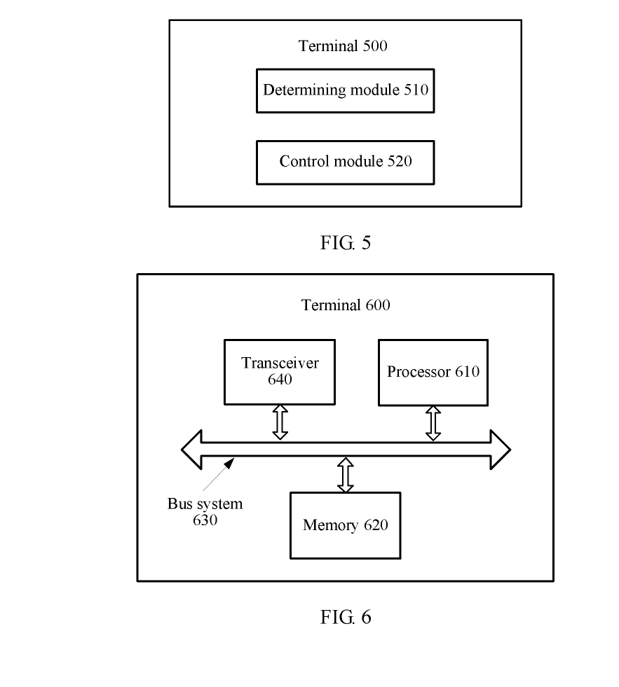

FIG. 5 is a schematic block diagram of a terminal 500 according to an embodiment of the present disclosure. The terminal 500 includes a determining module 510 configured to determine that a network signal is interrupted, and a control module 520 configured to maintain a first service connection between the terminal 500 and a server, where the first service connection is a service connection that is used for communication between the server and the terminal 500 before the network signal is interrupted.

The determining module 510 is further configured to determine that the network signal recovers to normal.

The determining module 510 is configured to determine whether an IP address of the terminal 500 changes within a first time interval. The first time interval is a time interval between a moment at which the network signal is interrupted and a moment at which the network signal recovers to normal.

The control module 520 is further configured to reuse the first service connection when the determining module 510 determines that the IP address of the terminal 500 does not change.

It should be understood that a function of the control module 520 may be implemented by a software program, for example, may be implemented by putting the software program into a process, or may be implemented by a software module on a hardware chip, or may be implemented by a combination of a hardware module and a software module, or the like.

Therefore, according to the service connection control apparatus in this embodiment of the present disclosure, when a network signal is interrupted, a service connection between a server and a terminal is not blindly disrupted. Instead, when an IP address of the terminal does not change after the network signal recovers, the original service connection may be reused, network delays caused by connection re-establishment are reduced, and a traffic bandwidth and power consumption of the terminal are reduced.

Optionally, in an embodiment, the terminal 500 further includes a transceiver module (not shown) configured to send a probe request message to the server when the determining module 510 determines that the IP address of the terminal 500 does not change, where the probe request message is used to detect a network status between the terminal 500 and the server, and receive a probe response message sent by the server, where the probe response message is a response message for the probe request message.

The control module 520 is further configured to reuse the first service connection when the probe response message indicates that the network status between the server and the terminal 500 is normal.

Optionally, in an embodiment, the control module 520 is further configured to establish a second service connection between the terminal 500 and the server when the probe response message indicates that the network status between the server and the terminal 500 is abnormal.

Optionally, in an embodiment, the control module 520 is further configured to reuse the first service connection when the IP address of the terminal 500 does not change within the first time interval, and the first time interval is less than a first time interval threshold.

Optionally, in this embodiment of the present disclosure, the control module 520 is further configured to reuse the first service connection when the IP address of the terminal does not change within the first time interval, and a distance between a first position and a second position of the terminal 500 is less than a first distance threshold, where the first position is a position of the terminal 500 when the network signal is interrupted, and the second position is a position of the terminal 500 when the network signal recovers to normal.

Therefore, according to the terminal 500 in this embodiment of the present disclosure, when a network signal is interrupted, a service connection is not blindly disrupted. Instead, it may be determined, according to whether an IP address of the terminal 500 changes after a network recovers, whether to reuse the original service connection or re-establish a service connection. Therefore, the original service connection can be reused to the maximum extent, network delays caused due to connection re-establishment are reduced, and a traffic bandwidth and power consumption of the terminal are reduced.

The terminal 500 according to this embodiment of the present disclosure may correspond to the terminal 500 in the service connection control method 200 in the foregoing embodiment of the present disclosure, and the foregoing and other operations and/or functions of the modules in the terminal 500 are separately performed to implement corresponding procedures of the foregoing method. Details are not repeated herein for brevity.

As shown in FIG. 6, a terminal 600 is further provided according to an embodiment of the present disclosure. As shown in FIG. 5, the terminal 600 includes a processor 610, a memory 620, a bus system 630, and a transceiver 640. The processor 610, the memory 620, and the transceiver 640 are connected to each other using the bus system 630. The memory 620 is configured to store an instruction. The processor 610 is configured to execute the instruction stored in the memory 620 in order to control the transceiver 640 to receive a signal or send a signal. The processor 610 is configured to determine that a network signal is interrupted, and when the network signal is interrupted, maintain a first service connection between the terminal and a server. The first service connection is a service connection that is used for communication between the server and the terminal 600 before the network signal is interrupted. The processor 610 is further configured to determine that the network signal recovers to normal, and determine whether an IP address of the terminal 600 changes within a first time interval. The first time interval is a time interval between a moment at which the network signal is interrupted and a moment at which the network signal recovers to normal. The processor 610 is further configured to reuse the first service connection when determining that the IP address of the terminal does not change.

It should be understood that the method 200 disclosed in the foregoing embodiment of the present disclosure may be applied to the processor 610, or be implemented by the processor 610. The processor 610 may be an integrated circuit chip and have a signal processing capability. In an implementation process, each step of the foregoing method 200 may be completed using an integrated logical circuit of hardware in the processor 610 or an instruction in a form of software. The foregoing processor 610 may be a general purpose processor, a digital signal processor (DSP), an application-specific integrated circuit (ASIC), a field-programmable gate array (FPGA), or another programmable logic device, discrete gate or transistor logic device, or discrete hardware component. The methods, steps, and logical block diagrams disclosed in the embodiments of the present disclosure may be implemented or performed. The general purpose processor may be a microprocessor or the processor may be any conventional processor or the like. Steps of the methods disclosed in the embodiments of the present disclosure may be directly performed and completed by a hardware decoding processor, or may be performed and completed using a combination of hardware and software modules in the decoding processor. The software module may be located in a mature storage medium in the field, such as a random access memory, a flash memory, a read-only memory (ROM), a programmable ROM (PROM), an electrically-erasable PROM (EEPROM), or a register. The storage medium is located in the memory 620, and the processor 610 reads information in the memory 620 and completes the steps in the foregoing methods in combination with hardware of the processor 610.

It may be understood that the memory 620 in the embodiments of the present disclosure may be a volatile memory or a nonvolatile memory, or may include a volatile memory and a nonvolatile memory. The non-volatile memory may be a ROM, a PROM, an Erasable PROM (EPROM), an EEPROM, or a flash memory. The volatile memory may be a random access memory (RAM), and is used as an external cache. RAMs in many forms such as a static RAM (SRAM), a dynamic RAM (DRAM), a synchronous DARM (SDRAM), a double data rate (DDR) SDRAM, an Enhanced SDRAM (ESDRAM), a synchlink DRAM (SLDRAM), and a direct rambus (DR) RAM may be used. Those are examples rather than limitative descriptions. The memory in the method and the terminal described in this specification intends to include, but is not limited to, these memories and any other memory of a suitable type.

It may be understood that the embodiments described in this specification may be implemented by hardware, software, firmware, middleware, microcode, or a combination thereof. For hardware implementation, a processor may be implemented in one or more ASIC, a DSP, a DSP device (DSPD), a programmable logic device (PLD), an FPGA, a general purpose processor, a controller, a micro-controller, a microprocessor, and other electronic units configured to execute the functions described in the present disclosure, or a combination of the above.

When the embodiments are implemented in software, firmware, middleware, microcode, program code, or a code segment, they may be stored in, for example, a machine-readable medium of a storage component. The code segment may indicate a process, a function, a subprogram, a program, a routine, a subroutine, a module, a software group, a type, or any combination of an instruction, a data structure, and a program statement. The code segment may be coupled to another code segment or a hardware circuit by transferring and/or receiving information, data, an independent variable, a parameter, or memory content. The information, the independent variable, the parameter, data, or the like may be transferred, forwarded, or sent in any suitable manner such as memory sharing, message transfer, token transfer, or network transmission.

For implementation by software, the technologies in this specification may be implemented by performing the functional modules (for example, a process and a function) in this specification. Software code may be stored in a memory and executed by a processor. The memory may be implemented inside the processor or outside the processor. In the latter case, the memory may be coupled to the processor by means of communication using various means known in the art.

The bus system 630 may include a power bus, a control bus, a status signal bus, and the like in addition to a data bus. However, for clear description, various types of buses in the figure are marked as the bus system 630.

Therefore, according to the terminal 600 in this embodiment of the present disclosure, when a network signal is interrupted, a service connection is not blindly disrupted. Instead, it may be determined, according to whether an IP address of the terminal 600 changes after a network recovers, whether to reuse the original service connection or re-establish a service connection. Therefore, the original service connection can be reused to the maximum extent, network delays caused due to connection re-establishment are reduced, and a traffic bandwidth and power consumption of the terminal are reduced.

The term “and/or” in this specification describes only an association relationship for describing associated objects and represents that three relationships may exist. For example, A and/or B may represent the following three cases, only A exists, both A and B exist, and only B exists. In addition, the character “/” in this specification generally indicates an “or” relationship between the associated objects.

It should be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of the present disclosure may be integrated into one processor, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the other approaches, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a ROM, a RAM, a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1.-18. (canceled)

19. A service coupling control method, comprising:
detecting, by a terminal, that a network signal is interrupted;
maintaining, by the terminal, a first service coupling to a server, the first service coupling being used for communication between the server and the terminal before the network signal is interrupted;
detecting, by the terminal, that the network signal recovers to normal; and
reusing, by the terminal, the first service coupling when an Internet Protocol (IP) address of the terminal does not change within a first time interval, the first time interval comprising a time interval between a moment at which the network signal is interrupted and a moment at which the network signal recovers to normal.

20. The method of claim 19, wherein reusing the first service coupling comprises:
detecting, by the terminal, that the IP address of the terminal does not change within the first time interval;
sending, by the terminal, a probe request message to the server detecting a network status between the terminal and the server;
receiving, by the terminal, a probe response message from the server comprising a response message for the probe request message; and
reusing, by the terminal, the first service coupling when the network status between the server and the terminal indicated by the probe response message is normal.

21. The method of claim 20, further comprising establishing, by the terminal, a second service coupling to the server when the network status between the server and the terminal indicated by the probe response message is abnormal.

22. The method of claim 19, wherein reusing the first service coupling comprises reusing, by the terminal, the first service coupling when the IP address of the terminal does not change within the first time interval and the first time interval is less than a first time interval threshold.

23. The method of claim 19, wherein reusing the first service coupling comprises reusing, by the terminal, the first service coupling when the IP address of the terminal does not change within the first interval and a distance between a first position and a second position of the terminal is less than a first distance threshold, the first position comprising a position of the terminal when the network signal is interrupted, and the second position comprising a position of the terminal when the network signal recovers to normal.

24. The method of claim 19, further comprising establishing, by the terminal, a third service coupling to the server when the IP address of the terminal changes within the first time interval.

25. The method of claim 22, further comprising establishing, by the terminal, a third service coupling to the server when the IP address of the terminal changes within the first time interval.

26. The method of claim 23, further comprising establishing, by the terminal, a third service coupling to the server when the IP address of the terminal changes within the first time interval.

27. The method of claim 22, further comprising establishing, by the terminal, a third service coupling to the server when the first time interval is greater than the first time e threshold.

28. The method of claim 23, further comprising establishing, by the terminal, a third service coupling to the server, when the distance is greater than the first distance threshold.

29. A terminal, comprising:
a memory;
a transceiver coupled to the memory;
a processor coupled to the transceiver and the memory using a bus system and configured to:
detect that a network signal is interrupted;
maintain a first service coupling between the terminal and a server_{;} the first service coupling being used for communication between the server and the terminal before the network signal is interrupted;
detect that the network signal recovers to normal; and
reuse the first service coupling when an Internet Protocol (IP) address of the terminal does not change within a first time interval, the first time interval comprising a time interval between a moment at which the network signal is interrupted and a moment at which the network signal recovers to normal.

30. The terminal of claim 29, wherein the processor is further configured to detect that the IP address of the terminal does not change within the first time interval, the transceiver being configured to:
send a probe request message to the server detecting a network status between the terminal and the server; and
receive a probe response message from the server comprising a response message for the probe request message, and
the processor being further configured to reuse the first service coupling when the network status between the server and the terminal indicated by the probe response message is normal.

31. The terminal of claim 30, wherein the processor is further configured to establish a second service coupling between the terminal and the server when the network status between the server and the terminal indicated by the probe response message is abnormal.

32. The terminal of claim 29, wherein the processor is further configured to reuse the first service coupling when the IP address of the terminal does not change within the first time interval and the first time interval is less than a first time interval threshold.

33. The terminal of claim 29, wherein the processor is further configured to reuse the first service coupling when the IP address of the terminal does not change within the first time interval and a distance between a first position and a second position of the terminal is less than a first distance threshold, the first position comprising a position of the terminal when the network signal is interrupted, and the second position comprising a position of the terminal when the network signal recovers to normal.

34. The terminal of claim 29, wherein the processor is further configured to establish a third service coupling to the server when the IP address of the terminal changes within the first time interval.

35. The method of claim 32, wherein the processor is further configured to establish a third service coupling to the server when the IP address of the terminal changes within the first time interval.

36. The method of claim 33, wherein the processor is further configured to establish a third service coupling to the server when the IP address of the terminal changes within the first time interval.

37. The method of claim 32, wherein the processor is further configured to establish a third service coupling to the server when the first time interval is greater than the first time interval threshold.

38. A non-transitory computer readable storage medium configured to store one or more programs, the one or more programs comprising instructions, and when executed, the one or more programs causing a terminal to be configured to:
detect that a network signal is interrupted;
maintain a first service coupling between the terminal and a server, the first service coupling being used for communication between the server and the terminal before the network signal is interrupted;
detect that the network signal recovers to normal; and
reuse the first service coupling when an Internet Protocol (IP) address of the terminal does not change within a first time interval, the first time interval comprising a time interval between a moment at which the network signal is interrupted and a moment at which the network signal recovers to normal.
